(19) United States
(12) Patent Application Publication
(10) Pub. No.: US 2024/0126191 A1
(43) Pub. Date: Apr. 18, 2024

(54) BELT DRIVING DEVICE AND IMAGE FORMING APPARATUS

(71) Applicant: FUJIFILM Business Innovation Corp., Tokyo (JP)

(72) Inventor: Satoshi EZAWA, Kanagawa (JP)

(73) Assignee: FUJIFILM Business Innovation Corp., Tokyo (JP)

(21) Appl. No.: 18/297,887

(22) Filed: Apr. 10, 2023

(30) Foreign Application Priority Data
Oct. 17, 2022 (JP) 2022-166290

(51) Int. Cl. G03G 15/16

(52) U.S. Cl. CPC G03G 15/1615; G03G 15/169; G03G 2215/1623

(57) ABSTRACT

A belt driving device includes: a belt; and a drive roll and driven rolls that rotate the belt wound around the rolls. As part of the driven rolls, a first driven roll and a second driven roll with a same roll diameter, each having a greatest exceeding eccentricity section or insufficient eccentricity section in a mutual common area are disposed in a non-displaced state in that order at positions with an interval in a rotational direction of the belt, and are driven to rotate so that greatest exceeding eccentricity sections or insufficient eccentricity sections each being the greatest exceeding eccentricity section or insufficient eccentricity section are in opposite phase at central positions in the rotational direction of contact portions of the belt with the first driven roll and the second driven roll.

### CROSS-REFERENCE TO RELATED APPLICATIONS

This application is based on and claims priority under 35 USC 119 from Japanese Patent Application No. 2022-166290 filed Oct. 17, 2022.

### BACKGROUND

### (i) Technical Field

The present disclosure relates to a belt driving device and an image forming apparatus.

### (ii) Related Art

Japanese Unexamined Patent Application Publication No. 2004-20852 (claim 7, FIG. 1) describes a color image forming apparatus that forms a color image by transferring images in different colors formed by a plurality of image forming stations in a superimposed state directly onto a belt-shaped member, or onto a recording medium transported by a belt-shaped member.

Japanese Unexamined Patent Application Publication No. 2004-20852 also states that the color image forming apparatus includes a driving force transmission unit that transmits a driving force to a belt driving roll so that the surface speed of the belt driving roll to drive the belt-shaped member circularly varies with a period which is the distance between the image forming stations divided by a natural number.

Japanese Patent No. 4735336 (claim 1, paragraph [0048], FIG. 2, FIG. 4) describes an image forming apparatus in which latent images are formed on four photoconductor drums by a writing unit, and are respectively developed into toner images by a developing unit, then the toner images are transferred onto an intermediate transfer belt to form superimposed toner images which are collectively transferred to a transfer material.

In addition, Japanese Patent No. 4735336 states that in the image forming apparatus, the intermediate transfer belt is stretched over at least three tension rollers provided inwardly, three of the four photoconductor drums are arranged at regular intervals so as to be in contact with the tension surface formed by connecting the outer circumferential surfaces of the first and second tension rollers in the belt running direction, the other photoconductor drum is arranged so as to be in contact with the tension surface downstream of the third tension roller, the second and third tension rollers are formed as a pair, and movable in opposite directions by the same distance.

### SUMMARY

Aspects of non-limiting embodiments of the present disclosure relate to providing a belt driving device and an image forming apparatus which are capable of reducing a speed variation which occurs in a portion of a belt that rotates by being wound around a drive roll and driven rolls, as compared to when the belt is supported by arranging a single driven roll having a greatest exceeding eccentricity section or insufficient eccentricity section, the speed variation being caused by eccentricity of the driven rolls, the portion being upstream or downstream of the driven roll in a rotational direction of the belt.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt driving device including:
a belt; and
a drive roll and driven rolls that rotate the belt wound around the rolls,
wherein as part of the driven rolls, a first driven roll and a second driven roll with a same roll diameter, each having a greatest exceeding eccentricity section or insufficient eccentricity section in a mutual common area are disposed in a non-displaced state in that order at positions with an interval in a rotational direction of the belt, and are driven to rotate so that greatest exceeding eccentricity sections or insufficient eccentricity sections each being the greatest exceeding eccentricity section or insufficient eccentricity section are in opposite phase at central positions in the rotational direction of contact portions of the belt with the first driven roll and the second driven roll.

### BRIEF DESCRIPTION OF THE DRAWINGS

Exemplary embodiments of the present disclosure will be described in detail based on the following figures, wherein:

FIG. 1 is a schematic view of a belt driving device in its entirety according to Exemplary Embodiment 1;

FIG. 2 is a schematic view of part of the belt driving device of FIG. 1;

FIG. 3 is a schematic view illustrating another configuration of part of the belt driving device of FIG. 2;

FIG. 4A is a schematic view related to measurement of a greatest exceeding eccentricity section or insufficient eccentricity section in a driven roll, and FIG. 4B is a schematic view of another part related to measurement of FIG. 4A;

FIG. 5 is a schematic view of part of a belt driving device according to Exemplary Embodiment 2;

FIG. 6 is a schematic view of a belt driving device in its entirety and a modification according to Exemplary Embodiment 3;

FIG. 7 is a schematic view of a belt driving device in its entirety and a modification according to Exemplary Embodiment 4;

FIG. 8 is a schematic view of an image forming apparatus in its entirety according to Exemplary Embodiment 5;

FIG. 9 is a schematic view of an imaging transfer unit for which the belt driving device of the image forming apparatus of FIG. 8 is used; and

FIG. 10A is a schematic view of part of a belt driving device in a comparative example, and FIG. 10B is a schematic view of part of a belt driving device in another comparative example.

### DETAILED DESCRIPTION

Hereinafter, an exemplary embodiment for implementing the present disclosure will be described.

### Exemplary Embodiment 1

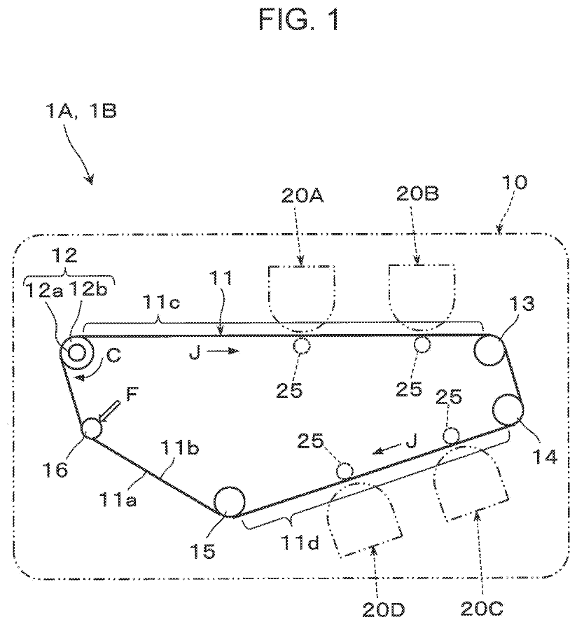

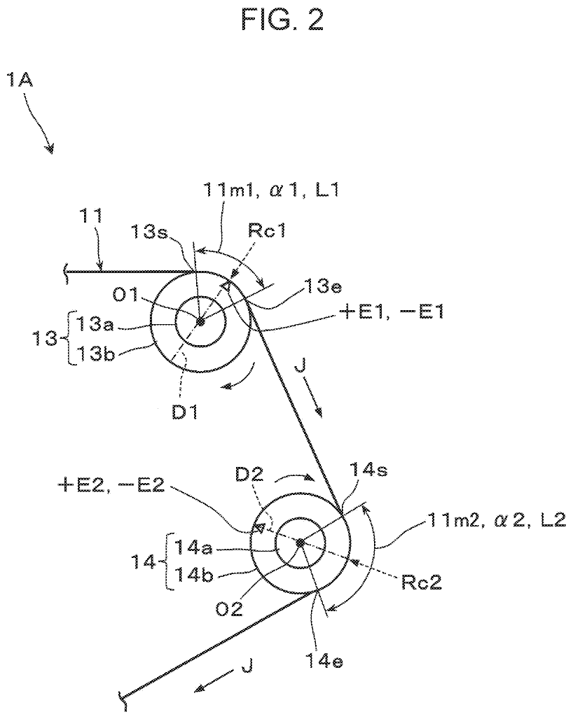

FIG. 1 and FIG. 2 illustrate Exemplary Embodiment 1 of the present disclosure. FIG. 1 conceptually illustrates a belt driving device 1A in its entirety according to Exemplary Embodiment 1, and FIG. 2 conceptually illustrates part (the part centered on a first driven roll and a second driven roll) of the belt driving device 1A.

In the present specification and the drawings, essentially the same components are labeled with the same symbol, and a redundant description of those components is omitted in the present specification.

Configuration of Belt Driving Device

The belt driving device 1A includes a housing 10, a belt 11, a drive roll 12 and driven rolls 13 to 16 that rotate the belt 11 wound around the rolls.

The housing 10 is a structure that supports the components such as the belt 11, and the drive roll 12 disposed in the structure.

When the belt driving unit 1A is used alone, the housing 10 is configured as a box-shaped structure including an exterior portion surrounded by an exterior material, for example. Alternatively, when the belt driving unit 1A is used as part of another device, there is no exterior portion surrounded by an exterior material, for example, and the housing 10 is configured as a structure consisting of only an internal portion, such as a framework that supports the components such as the belt 11, and the drive roll 12 disposed in the structure.

The belt 11 is an annular deformable member that moves in a circular manner by being rotatably wound around the drive roll 12 and the driven rolls 13 to 16 as necessary with a tensile force applied thereto. The belt 11 is formed as a member which elastically extends in length when being wound around the rolls with a tensile force applied thereto.

The belt 11 is favorably used for application that demands stability of the rotational movement speed and the moving state of the belt surface.

Thus, for example, when the belt driving device 1A is used in an image forming apparatus to form an image, the belt 11 is applicable to an image holding belt, such as an intermediate transfer belt that temporarily holds an unfixed image to be transferred on an outer peripheral surface 11a of the belt 11 to transport the image, and a photoreceptor belt on which an electrostatic latent image is formed and held. In addition, for example, when the belt driving device 1A is used in combination with a processing unit that performs a process of transferring a material to a to-be-processed member held on the outer peripheral surface 11a of the belt 11 and transported, the belt 11 is applicable to a transport belt such as a member transport belt that transports the to-be-processed member.

The drive roll 12 is a roll having a structure consisting of a rotational shaft 12a and a roll body 12b fixed and provided to the outer peripheral surface of the rotational shaft 12a.

In addition, the drive roll 12 is rotatably disposed in a non-displaced state at a predetermined position of the housing 10. The rotational shaft 12a receives a rotational force from a driving device which is not illustrated, thus the drive roll 12 rotates at a required speed in a required direction C to drive and move the belt 11 in a circular manner in a required rotational direction J.

Each of the driven rolls 13 to 16 has a structure consisting of a rotational shaft and a roll body fixed and provided to the outer peripheral surface of the rotational shaft. As illustrated representatively in FIG. 2, the driven roll 13 consists of a rotational shaft 13a and a roll body 13b, and the driven roll 14 consists of a rotational shaft 14a and a roll body 14b.

In addition, the driven rolls 13 to 16 are rotatably disposed at respective predetermined positions allocated corresponding to a required form when the belt 11 is wound around the driven rolls 13 to 16 in the housing 10. The driven rolls 13 to 16 receive a force from the belt 11 that moves in a circular manner, thus are driven to rotate.

In Exemplary Embodiment 1, the driven roll 13 is disposed at a position with a required interval from the drive roll 12 in a substantially horizontal direction, and the driven roll 14 is disposed at a position diagonally downward from the driven roll 13 with a required interval therefrom. Also, in Exemplary Embodiment 1, the driven roll 15 is disposed at the lowest position diagonally downward from the driven roll 14 with a required interval therefrom, and the driven roll 16 is disposed at a position between the drive roll 12 and the driven roll 15.

Thus, when being wound around the drive roll 12 and the driven rolls 13 to 16, the belt 11 in Exemplary Embodiment 1 forms a substantially horizontal belt surface at an upper position, which extends in a substantially horizontal direction, and also forms slanted belt surfaces that respectively extend diagonally downward from the upstream end and the downstream end of the substantially horizontal belt surface in the rotational direction J.

The belt 11 is wound around the rolls so as to have an approximately inverted triangle shape as a whole. Also, the drive roll 12 and the driven rolls 13 to 16 are each provided inside the belt 11, and in contact with an inner peripheral surface 11b to support the belt 11.

The driven roll 13 and the driven roll 14, which are part of the driven rolls 13 to 16, are configured as the later-described first driven roll and second driven roll, respectively.

The driven roll 15 is disposed as the driven roll provided at the lowest position.

The driven roll 16 is disposed in a state of being displaceable in a direction closer to and in a direction away from the inner peripheral surface 11b of the belt 11, and is configured as a tensile force applying roll (tension) that comes into contact with the inner peripheral surface 11b to provide a tensile force by applying a required pressing force F.

In the belt driving device 1A, instead of adopting a configuration in which one driven roll (for example, the driven roll 13 only) rather than the driven rolls 13 and 14 is disposed, from the viewpoint of measures to reduce a speed variation of the belt 11 caused due to eccentricity of a driven roll, a configuration is adopted in which the driven roll 13 as an example of the first driven roll and the driven roll 14 as an example of the second driven roll are disposed.

In this situation, as illustrated in FIG. 2, the driven roll 13 and the driven roll 14 are driven rolls with the same dimension of roll diameters D1, D2.

Also, the driven roll 13 and the driven roll 14 are driven rolls that have a greatest exceeding eccentricity section (+E) or insufficient eccentricity section (−E) in a mutual common area.

Here, the greatest exceeding eccentricity section (+E) is an exceeding eccentricity section that is eccentric by a greatest amount exceeding a required roll diameter (the outer peripheral surface) among multiple eccentricity sections present in the roll products (finished products) which are scheduled to be used as the driven rolls 13, 14.

The greatest insufficient eccentricity section (−E) is an insufficient eccentricity section that is insufficient and eccentric by a greatest amount with respect to a required roll diameter among multiple eccentricity sections present in the roll products which are scheduled to be used as the driven rolls 13, 14.

Each of the exceeding eccentricity section (+E) and the insufficient eccentricity section (−E) may occur due to a variation in manufacturing.

The greatest amount refers to a case in which a measured value of a circumferential runout of a surface portion which is in contact with the belt 11 has a greatest value relative to a fixed section at the time of mounting to the device.

Also, the mutual common area refers to an area where the displacement amount at the position in the axial direction indicating the greatest exceeding eccentricity section (+E) or insufficient eccentricity section (−E) in the roll products scheduled to be used as the driven rolls 13, 14 has a relationship falling within a range of approximately ½ of the axial length (the length in the axial direction) of a surface portion in contact with the belt 11.

Furthermore, information on the greatest exceeding eccentricity section (+E) and the greatest insufficient eccentricity section (−E) is obtained through measurement by the following method, for example.

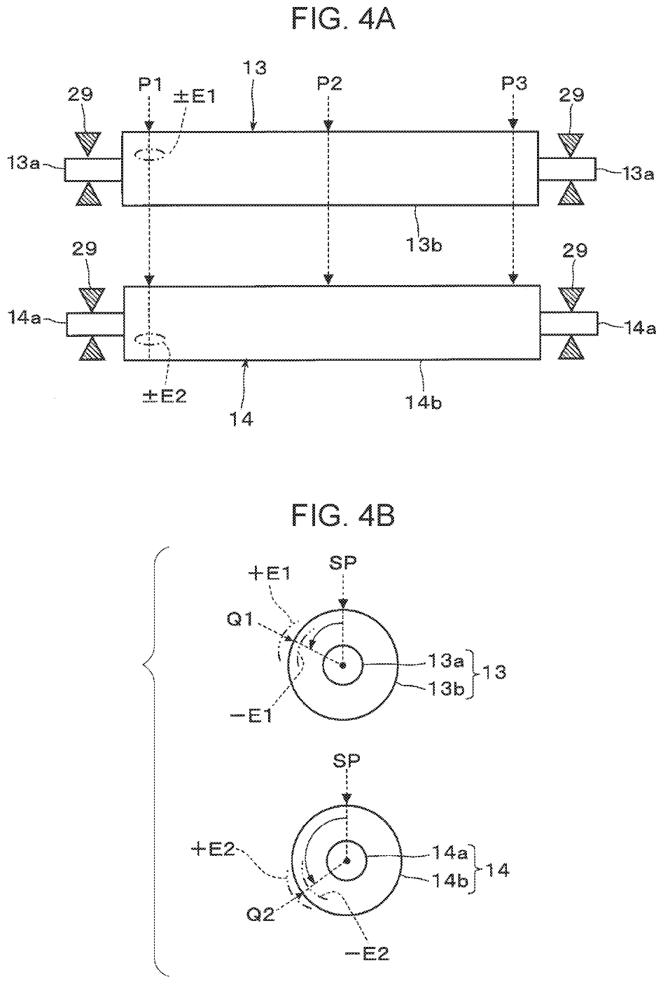

Specifically, for the measurement, as illustrated in FIGS. 4A and 4B, the roll products to be measured which are scheduled to be used as the driven rolls 13, 14 are first attached to the same bearing (including the bearing in the belt driving device actually mounted) 29.

Subsequently, measurement is made by measuring the heights (coordinates) of the surfaces of the roll bodies 13b, 14b of the roll products as circumferential runouts in association with positional information on the surface in the axial direction and the circumferential direction of the rolls, while rotating the attached roll products at a constant speed.

The measurement may be made over at least a range on the surfaces of the roll bodies of the roll products, the range being scheduled to be in contact with the belt 11 wound over the range.

In FIGS. 4A and 4B, the roll products to be measured which are scheduled to be used as the driven rolls 13, 14 are displayed as the driven roll 13 and the driven roll 14 for the sake of convenience.

Also, FIG. 4A illustrates a case in which the greatest exceeding eccentricity section (+E) or insufficient eccentricity section (−E) is located in an area centered at the position denoted by P1 of the roll bodies 13b, 14b in the axial direction. Incidentally, the roll bodies 13b, 14b may have multiple eccentricity sections (+E) or insufficient eccentricity sections (−E), for example, at other positions such as P2, P3 except for the position P1 illustrated in FIG. 4A in the axial direction, but it is assumed that each of those sections is not the greatest.

Also, in FIG. 4B, the outer peripheral surfaces of the roll bodies 13b, 14b indicated by a solid line are regarded as the target reference position of the roll diameter D, and the greatest exceeding eccentricity section (+E) and the greatest insufficient eccentricity section (−E) are illustrated by a chain double-dashed line in an exaggerated state. A symbol SP in FIG. 4B indicates a measurement start point of the roll bodies 13b, 14b in the circumferential direction, the start point being determined at the time of measurement.

At the time of measurement, a circumferential runout is measured using a measuring instrument such as (ID-C112JK) manufactured by Mitutoyo Corporation.

As a result of measurement, FIG. 4B illustrates a case in which the greatest exceeding eccentricity sections (+E1, +E2) or the greatest insufficient eccentricity sections (−E1, −E2) in the roll bodies 13b, 14b of the roll products scheduled to be used as the driven rolls 13, 14 are present at different positions Q1, Q2 from the measurement start point SP.

Incidentally, the series of measurement described above may be made as exclusive work in an assembly process, however, may be incorporated in a roll product inspection process as a work and performed, then the result of measurement may be stored for later use. Alternatively, information on the greatest exceeding eccentricity section (+E) and the greatest insufficient eccentricity section (−E) may be measured by another measurement method.

In the belt driving device 1A, as illustrated in FIG. 2, the driven roll 13 and the driven roll 14 are disposed in a non-displaced state in that order at positions with a required interval in the rotational direction J of the belt 11.

The above-mentioned non-displaced state is a state in which the driven roll 13 and the driven roll 14 are rotatably disposed at fixed positions. In other words, the non-displaced state is a state of being fixed and immovable, in a direction closer to and in a direction away from the inner peripheral surface 11b of the belt 11, for example. The driven roll 14 is disposed downstream of the driven roll 13 in the rotational direction J of the belt 11.

Moreover, as illustrated in FIG. 2, the driven roll 13 and the driven roll 14 in the belt driving device 1A are configured so that the greatest exceeding eccentricity sections (+E1, +E2) or insufficient eccentricity sections (−E1, −E2) are driven to rotate in opposite phase at central positions Rc1, Rc2 along the rotational direction J of respective contact portions 11m1, 11m2 of the belt 11 with the driven roll 13 and the driven roll 14.

Specifically, the driven roll 13 and the driven roll 14 are configured so that the greatest exceeding eccentricity section (+E1) in the driven roll 13 and the greatest exceeding eccentricity section (+E2) in the driven roll 14 are driven to rotate in opposite phase at the central positions Rc1, Rc2 of the contact portions 11m1, 11m2 of the belt 11.

In this situation, the greatest exceeding eccentricity section (+E1) and the greatest exceeding eccentricity section (+E2) may have the same greatest value or close greatest values, but may have different greatest values.

In addition, the driven roll 13 and the driven roll 14 may be configured so that the greatest insufficient eccentricity section (−E1) in the driven roll 13 and the greatest insufficient eccentricity section (−E2) in the driven roll 14 are driven to rotate in opposite phase at the central positions Rc1, Rc2 of the contact portions 11m1, 11m2 of the belt 11.

Also, in this situation, the greatest insufficient eccentricity section (−E1) and the greatest insufficient eccentricity section (−E2) may have the same greatest value or close greatest values, but may have different greatest values.

One of the following configurations is selected and adopted: a configuration in which the greatest exceeding eccentricity sections (+E1, +E2) are in the opposite phase and a configuration in which the greatest insufficient eccentricity sections (−E1, −E2) are in the opposite phase. In this situation, for example, the configuration having a relatively higher greatest value may be adopted.

However, as an exception, both of the two configurations may be adopted at the same time when the interval between the greatest exceeding eccentricity section (+E1) and the greatest insufficient eccentricity section (−E1) in the driven roll 13 in the circumferential direction is equal to the interval between the greatest exceeding eccentricity section (+E2) and the greatest insufficient eccentricity section (−E2) in the driven roll 14 in the circumferential direction.

In the driven roll 13 and the driven roll 14, as shown in parenthesis of FIG. 2, the respective contact portions 11m1, 11m2 of the belt 11 are such that contact start positions 13s, 14s and contact end positions 13e, 14e have angles (central angles or lap angles) α1, α2 around roll centers O1, O2, respectively. The contact portions 11m1, 11m2 have lengths L1, L2 in the rotational direction J.

In the driven roll 13 and the driven roll 14, the angles α1, α2 and the lengths L1, L2 of the contact portions 11m1, 11m2 of the belt 11 can be made relatively smaller or shorter than the corresponding angles and lengths when the driven roll 13 and the driven roll 14 are replaced by one driven roll.

The above-mentioned opposite phase means that the greatest exceeding eccentricity sections (+E1, +E2) or insufficient eccentricity sections (−E1, −E2) have a relationship of being located at opposite ends (present at opposite positions) at the central positions Rc1, Rc2 in the roll bodies 13b, 14b of the driven rolls 13, 14 in the diameter direction (the direction along the roll diameters D1, D2 passing through the roll centers O1, O2). The opposite positions in the parenthesis include the positions opposite to the central positions Rc1, Rc2 in the roll bodies 13b, 14b with respect to the roll centers O1, O2 as well as the positions displaced in a range of ±5-degree central angle at the center of the opposite positions.

FIG. 2 illustrates a case in which when the greatest exceeding eccentricity section (+E1) in the driven roll 13 is at the central position Rc1 of the roll body 13b, the greatest exceeding eccentricity section (+E2) in the driven roll 14 is at the position on the opposite to the central position Rc2 of the roll body 14b in the diameter direction.

Also, FIG. 2 selectively illustrates in parenthesis a case in which when the greatest insufficient eccentricity section (−E1) in the driven roll 13 is at the central position Rc1 of the roll body 13b, the greatest insufficient eccentricity section (−E2) in the driven roll 14 is at the position on the opposite to the central position Rc2 of the roll body 14b in the diameter direction.

The driven roll 13 and the driven roll 14 in Exemplary Embodiment 1 are configured to be synchronized and driven to rotate. Thus, the driven roll 13 and the driven roll 14 rotate in a state of the opposite phase maintained between the greatest exceeding eccentricity sections (+E) or insufficient eccentricity sections (−E).

In addition, the driven roll 13 and the driven roll 14 are configured to be coupled by a timing belt 18 and driven to rotate.

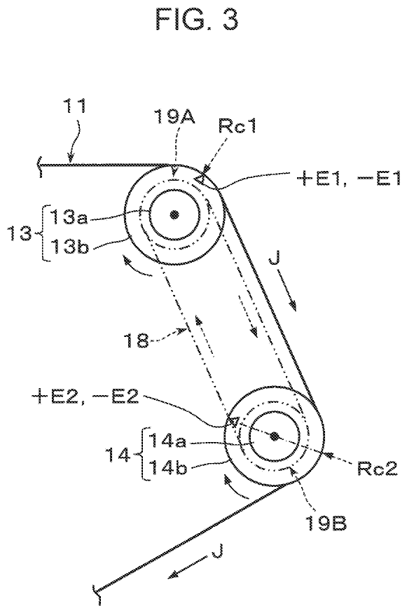

In the timing belt 18, the inner peripheral surface of a rotary transmission belt is provided with gear teeth such as rack teeth, for example. As illustrated in FIG. 3, the timing belt 18 is wound around pulleys 19A, 19B with gear teeth so that corresponding gear teeth are engaged with each other, the pulleys 19A, 19B being fixed and mounted on the rotational shaft 13a of the driven roll 13 and the rotational shaft 14a of the driven roll 14, respectively. Thus, the driven roll 13 and the driven roll 14 are maintained in synchronized rotation by the timing belt 18.

Furthermore, in the belt driving device 1A, as illustrated in FIG. 2, it is configured that the difference (its absolute value) between the length L1 of the contact portion 11m1 of the belt 11 with the driven roll 13, and the length L2 of the contact portion 11m2 of the belt 11 with the driven roll 14 is less than or equal to 20%.

When the difference between the length L1 and the length L2 exceeds 20%, an operational effect of reducing a temporary speed variation which occurs in the later-described part of the belt 11 is unlikely to be obtained, the operational effect being due to arrangement of the driven roll 13 and the driven roll 14.

Operation of Belt Driving Device

In thus configured belt driving device 1A, when the drive roll 12 rotates in the direction as indicated by arrow C, the belt 11 is supported by the drive roll 12 and the driven rolls 13 to 16, and rotated in the rotational direction J and moved in a circular manner.

The driven rolls 13 to 16 then are given a tensile force, and driven to rotate by receiving the force of the belt 11 in circular movement while being in contact with the belt 11. Also, the driven roll 13 and the driven roll 14 then are synchronized and driven to rotate.

When a configuration is adopted in which the greatest exceeding eccentricity sections (+E1, +E2) are in the opposite phase in the belt driving device 1A, once the belt driving device 1A is operated, the driven roll 13 and the driven roll 14 are moved as follows.

Specifically, in the driven roll 13 and the driven roll 14 in this situation, when the greatest exceeding eccentricity section (+E1) in the driven roll 13 reaches the central position Rc1 of the contact portion 11m1 of the belt 11 as illustrated in FIG. 2, the greatest exceeding eccentricity section (+E2) in the driven roll 14 reaches the surface portion of the roll body 14b at the position opposite to the central position Rc2 of the contact portion 11m2 of the belt 11.

The belt 11 then passes through a surface portion bulging outward of the roll body 13b due to the greatest exceeding eccentricity section (+E1) at the central position Rc1 of the contact portion 11m1 of the belt 11 in the driven roll 13, thus the belt 11 is moved in a state of being temporarily pushed outward of the driven roll 13.

On the other hand, in the belt 11 then, the greatest exceeding eccentricity section (+E2) is not present at the central position Rc2 of the contact portion 11m2 of the belt 11 in the driven roll 14, thus the belt 11 does not pass through a surface portion bulging outward of the roll body 14b due to the exceeding eccentricity section (+E2). Thus, the belt 11 is not moved in a state of being temporarily pushed outward of the driven roll 14.

As a result, when the greatest exceeding eccentricity section (+E1) in the driven roll 13 reaches the central position Rc1, the belt 11 is not moved at the same time in a state of being pushed outward at the central position Rc2 of the driven roll 14 because the effect of the greatest exceeding eccentricity section (+E2) is not provided. Consequently, in the belt 11, a temporary speed variation of a belt portion downstream of the driven roll 14 in the rotational direction J is reduced.

The speed variation then is a sine wave-like variation in a strict sense, and also instantaneous deceleration in most cases.

When a configuration is adopted in which the greatest insufficient eccentricity sections (−E1, −E2) are in the opposite phase in the belt driving device 1A, once the belt driving device 1A is operated, the driven roll 13 and the driven roll 14 are moved as follows.

Specifically, in the driven roll 13 and the driven roll 14 in this situation, as selectively shown in parenthesis of FIG. 2, when the greatest insufficient eccentricity section (−E1) in the driven roll 13 reaches the central position Rc1 of the contact portion 11m1 of the belt 11, the greatest insufficient eccentricity section (−E2) in the driven roll 14 reaches the surface portion of the roll body 14b at the position opposite to the central position Rc2 of the contact portion 11m2 of the belt 11.

The belt 11 then passes through a surface portion depressed inward of the roll body 13b due to the greatest insufficient eccentricity section (−E1) at the central position Rc1 of the contact portion 11m1 of the belt 11 in the driven roll 13, thus the belt 11 is moved in a state of being temporarily depressed inward of the driven roll 13.

On the other hand, in the belt 11 then, the greatest insufficient eccentricity section (−E2) is not present at the central position Rc2 of the contact portion 11m2 of the belt 11 in the driven roll 14, thus the belt 11 does not pass through a surface portion depressed inward of the roll body 14b due to the absence of the insufficient eccentricity section (−E2). Thus, the belt 11 is not moved in a state of being temporarily depressed inward of the driven roll 14.

As a result, when the greatest insufficient eccentricity section (−E1) in the driven roll 13 reaches the central position Rc1, the belt 11 is not moved at the same time in a state of being depressed inward at the central position Rc2 of the driven roll 14 because the effect of the greatest insufficient eccentricity section (−E2) is not provided. Consequently, in the belt 11, a temporary speed variation of a belt portion downstream of the driven roll 14 in the rotational direction J is reduced.

The speed variation then is a sine wave-like variation in a strict sense, and also instantaneous acceleration in most cases.

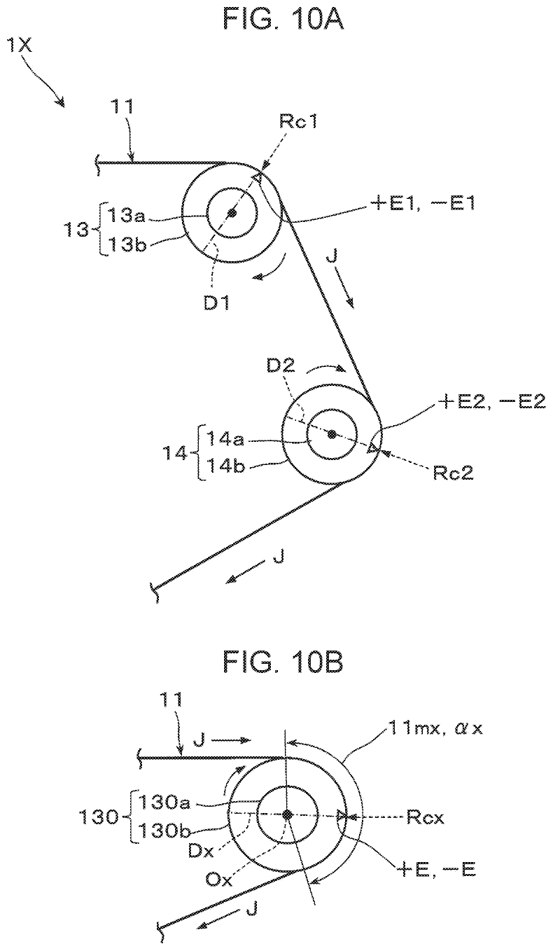

As described above, in the belt driving device 1A, a speed variation of the belt 11 which occurs due to eccentricity of a driven roll, in a portion upstream or downstream of the driven roll in the rotational direction J is reduced, as compared to when one driven roll 130 having the greatest exceeding eccentricity section (+E) or insufficient eccentricity section (−E) is disposed as illustrated in FIG. 10B as well as to a belt driving device 1X in a comparative example illustrated in FIG. 10A.

In the belt driving device 1X in the comparative example, the driven roll 13 and the driven roll 14 are configured to be disposed and driven to rotate so that the greatest exceeding eccentricity sections (+E) or insufficient eccentricity sections (−E) are in phase at substantially the central positions Rc1, Rc2 in the rotational direction J of the contact portions of the belt 11 with the driven roll 13 and the driven roll 14.

The substantially the central positions Rc1, Rc2 are positions with a central angle (displacement angle) displaced upstream or downstream from the central positions Rc1, Rc2 of the belt 11 in the rotational direction J within a range less than 20 degrees, for example.

In the belt driving device 1X in the comparative example, due to the greatest exceeding eccentricity sections (+E1, +E2) or insufficient eccentricity sections (−E1, −E2) respectively possessed by the driven roll 13 and the driven roll 14, a temporary speed variation, such as instantaneous acceleration or deceleration, is likely to occur in a portion of the belt 11 upstream of the driven roll 13 in the rotational direction J and/or a portion of the belt 11 upstream of the driven roll 14 in the rotational direction J.

Also, the belt driving device 1A is effective when the driven roll 13 as the first driven roll and the driven roll 14 as the second driven roll are disposed instead of one driven roll 130 in which the angle (the central angle, lap angle) ax of a contact portion 11mx of the belt 11 is a relatively large angle as illustrated in FIG. 10B. The angle αx which is a relatively large is an angle greater than or equal to 90 degrees, for example. The driven roll 130 is a driven roll having the greatest exceeding eccentricity section (+E) or insufficient eccentricity section (−E).

That is, when the one driven roll 130 is used, the amount of effect of movement of the belt 11 pushed outward of a roll body 130b of the driven roll 130 due to the eccentricity (the greatest exceeding eccentricity section +E) of the driven roll 130 tends to increase in proportion to the relatively large angle αx. In addition, the amount of effect of movement of the belt 11 depressed inward of the roll body 130b due to the eccentricity (the greatest insufficient eccentricity section −E) of the driven roll 130 tends to increase in proportion to the relatively large angle αx.

Consequently, in the belt 11 then, the speed of the belt 11 in a portion upstream or downstream of the driven roll 130 in the rotational direction J is likely to vary temporarily.

In addition, as the roll diameter Dx and the roll length of the driven roll 130 are increased according to demand for upsizing the belt driving device, eccentricity is likely to occur, and a temporary speed variation is likely to be caused due to such eccentricity.

Also, in the belt driving device 1A, the driven roll 13 and the driven roll 14 are coupled by the timing belt 18. Thus, in the belt driving device 1A, variation in the phase relationship due to slack of the belt 11 and a slight difference between the outer diameters of rolls such as the driven rolls 13, 14 is prevented, and as a result, the effect of reducing the speed variation of the belt 11 is maintained.

In addition, the belt driving device 1A is configured so that the difference between the length L1 of the contact portion 11m1 of the belt 11 with the driven roll 13 and the length L2 of the contact portion 11m2 of the belt 11 with the driven roll 14 is less than or equal to 20%.

Therefore, the above-described operational effect of reducing a temporary speed variation of the belt 11 due to disposition of the driven roll 13 and the driven roll 14 is likely to be obtained, as compared to when a configuration is adopted in which the difference between the length L1 and the length L2 exceeds 20%.

A configuration may be adopted in which the length L1 and the length L2 are equal. When such as a configuration is adopted, as compared to when the length L1 and the length L2 are different, the above-described operational effect of reducing a speed variation of the belt 11 is more likely to be obtained due to cancellation of a sine wave-like variation of the speed variation.

In addition, in the belt driving device 1A, like the technique described in Japanese Unexamined Patent Application Publication No. 2004-20852, it is possible to use a driving force transmission unit that transmits a driving force to the drive roll 12 so that the surface speed of the drive roll 12 of the belt 11 varies with a period which is the distance between the image forming stations (multiple processing units) divided by a natural number.

Furthermore, in the belt driving device 1A, when two driven rolls 13, 14 are configured to be movable in opposite directions by the same distance as in the technique described in Japanese Patent No. 4735336, a path variation and a tension variation of the belt 11 is likely to occur due to movement of the two driven rolls 13, 14 in opposite directions by the same distance. Moreover, in this situation, another misregistration may be caused due to a path variation or a tension variation of the belt 11.

In this regard, in the belt driving device 1A, the occurrence of a path variation and a tension variation of the belt 11 is also reduced as in the technique described in Japanese Patent No. 4735336.

When Processing Unit is Disposed in Belt Driving Device

Furthermore, in the belt driving device 1A, as illustrated by a chain double-dashed line in FIG. 1, it is possible to dispose two upstream processing units 20A, 20B on a first belt surface 11c of the belt 11 and two downstream processing units 20C, 20D on a second belt surface 11d of the belt 11 to use the processing units.

In this situation, the first belt surface 11c is a belt surface for processing work, which is first formed upstream of the driven roll 13 in the rotational direction J of the belt 11. The first belt surface 11c in Exemplary Embodiment 1 is the belt surface formed between the driven roll 13 and the drive roll 12 which is first disposed upstream of the driven roll 13 in the rotational direction J.

The second belt surface 11d is a belt surface for processing work, which is first formed downstream of the driven roll 14 in the rotational direction J of the belt 11. The second belt surface 11d in Exemplary Embodiment 1 is the belt surface formed between the driven roll 14 and the drive roll 15 which is first disposed downstream of the driven roll 14 in the rotational direction J.

The upstream processing units 20A, 20B perform a process of transferring a material to the first belt surface 11c. The downstream processing units 20C, 20D perform a process of transferring a material to the second belt surface 11d.

Symbols 25 in FIG. 1 indicate members (holding members) that each come into contact with the inner peripheral surface 11b of the belt 11 to hold the first belt surface 11c on which processing work is performed by the upstream processing units 20A, 20B, and the second belt surface 11d on which processing work is performed by the downstream processing units 20C, 20D. In Exemplary Embodiment 1, driven rolls are used as the holding members 25.

For example, when the belt 11 is an intermediate transfer belt, an imaging transfer unit is applied to the upstream processing units 20A, 20B and the downstream processing units 20C, 20D, the imaging transfer unit being configured to produce unfixed toner images as an example of a material and transfer the toner images to the outer peripheral surface 11a of the belt 11. In this situation, the holding members 25 are transfer rolls.

Also, in this situation, the belt driving device 1A is used as a belt driving device in the image forming apparatus, and constitutes part of the image forming apparatus. For example, when the belt 11 is a photoreceptor belt, a latent image former is applied to the upstream processing units 20A, 20B and the downstream processing units 20C, 20D, the latent image former being configured to radiate light as an example of a material to the outer peripheral surface 11a of the belt 11 to form an electrostatic latent image. Also, in this situation, the belt driving device 1A is used as a belt driving device in the image forming apparatus, and constitutes part of the image forming apparatus.

In the belt driving device 1A in which the upstream processing units 20A, 20B and the downstream processing units 20C, 20D are disposed, processing is successively performed by the upstream processing units 20A, 20B on the first belt surface 11c of the belt 11 that rotates in the rotational direction J. In addition, in the belt driving device 1A, processing is successively performed by the downstream processing units 20C, 20D on the second belt surface 11d of the belt 11 that rotates in the rotational direction J.

In this situation, the processing by the downstream processing units 20C, 20D is performed after alignment with the position (the position on the outer peripheral surface 11a) on the belt 11, for which a process is performed by the upstream processing units 20A, 20B. The respective processes by the upstream processing units 20A, 20B are also performed after position alignment. The respective processes by the upstream processing units 20A, 20B and the respective processes by the downstream processing units 20C, 20D are also performed after position alignment.

In the belt driving device 1A in which the upstream processing units 20A, 20B and the downstream processing units 20C, 20D, as described above, as compared to when the driven roll 13 and the driven roll 14 are not disposed as part of the driven rolls, a temporary speed variation, which occurs in a portion of the belt 11 upstream or downstream of the driven roll 14 in the rotational direction J is reduced.

As a result, the processing by the downstream processing units 20C, 20D on the second belt surface 11d of the outer peripheral surface 11a is prevented from displacement from the position on which the outer peripheral surface 11a of the first belt surface 11c is processed by the upstream processing units 20A, 20B, the displacement being due to a slight variation in the position (timing) at which the belt 11 passes through, affected by the occurrence of the temporary speed variation of the belt 11.

### Exemplary Embodiment 2

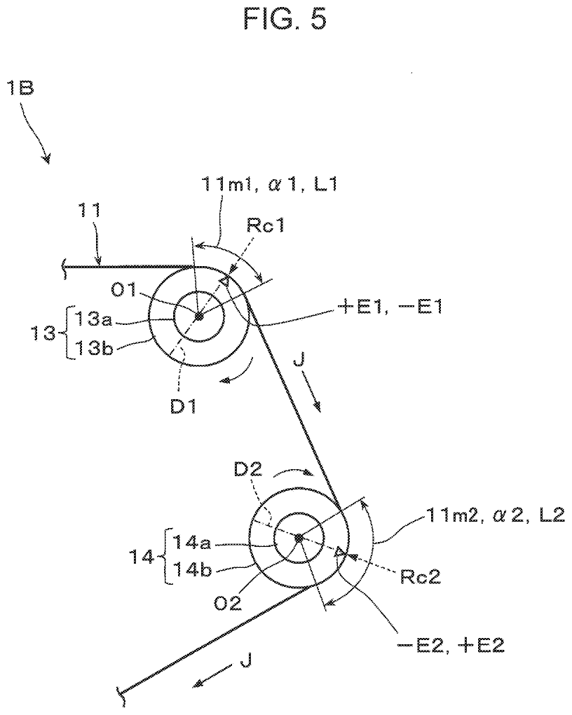

FIG. 5 conceptually illustrates part (the part centered on the first driven roll and the second driven roll) of a belt driving device 1B according to Exemplary Embodiment 2.

The belt driving device 1B has the same configuration as that of the belt driving device 1A according to Exemplary Embodiment 1 except that part of the configuration related to the driven roll 13 and the driven roll 14 is changed in the following manner.

In the belt driving device 1B, the driven roll 13 and the driven roll 14 are changed and configured to be driven to rotate so that the greatest exceeding eccentricity sections (+E1, +E2) and the greatest insufficient eccentricity sections (−E1, −E2) are in phase at the central positions Rc1, Rc2 along the rotational direction J of the contact portions 11m1, 11m2 of the belt 11 with the driven roll 13 and the driven roll 14.

In the case of a combination of the greatest exceeding eccentricity section (+E1) in the driven roll 13 and the greatest insufficient eccentricity section (−E2) in the driven roll 14, the “in phase” indicates a relationship such that when the greatest exceeding eccentricity section (+E1) reaches the central position Rc1 of the driven roll 13, the greatest insufficient eccentricity section (−E2) is present at the same time or substantially at the same time at the central position Rc2 of the driven roll 14.

In the case of a combination of the greatest insufficient eccentricity section (−E1) in the driven roll 13 and the greatest exceeding eccentricity section (+E2) in the driven roll 14, the “in phase” indicates a relationship such that when the greatest insufficient eccentricity section (−E1) reaches the central position Rc1 of the driven roll 13, the greatest exceeding eccentricity section (+E2) is present at the same time or substantially at the same time at the central position Rc2 of the driven roll 14.

A case of being “present substantially at the same time” means to be present at a position displaced in a range of ±5-degree central angle at the center of the position at which being present completely at the same time.

FIG. 5 selectively shows in parenthesis together that when the greatest exceeding eccentricity section (+E1) or insufficient eccentricity section (−E1) in the driven roll 13 is at the central position Rc1 of the roll body 13b, the greatest exceeding eccentricity section (+E2) or insufficient eccentricity section (−E2) in the driven roll 14 is at the central position Rc2 of the roll body 14b.

Operation of Belt Driving Device

In the belt driving device 1B, when the drive roll 12 rotates in the direction as indicated by the arrow C, as in the belt driving device 1A according to Exemplary Embodiment 1, the belt 11 is supported by the drive roll 12 and the driven rolls 13 to 16, and rotated in the rotational direction J and moved in a circular manner.

In the belt driving device 1B, when a configuration is adopted in which the greatest exceeding eccentricity section (+E1) in the driven roll 13 and the greatest insufficient eccentricity section (−E2) in the driven roll 14 are in phase, once the belt driving device 1B is operated, the driven roll 13 and the driven roll 14 are moved as follows.

Specifically, in the driven roll 13 and the driven roll 14, as illustrated in FIG. 5, when the greatest exceeding eccentricity section (+E1) in the driven roll 13 reaches the central position Rc1 of the contact portion 11m1 of the belt 11, the greatest insufficient eccentricity section (−E2) in the driven roll 14 reaches the central position Rc2 of the contact portion 11m2 of the belt 11.

The belt 11 then passes through a surface portion bulging outward of the roll body 13b due to the greatest exceeding eccentricity section (+E1) at the central position Rc1 of the contact portion 11m1 of the belt 11 in the driven roll 13, thus the belt 11 is moved in a state of being temporarily pushed outward of the driven roll 13.

On the other hand, the belt 11 then passes through a surface portion depressed inward of the roll body 14b due to the greatest insufficient eccentricity section (−E2) at the central position Rc2 of the contact portion 11m2 of the belt 11 in the driven roll 14, thus the belt 11 is moved in a state of being temporarily depressed inward of the driven roll 14.

Consequently, even when the greatest exceeding eccentricity section (+E1) in the driven roll 13 reaches the central position Rc1 and the belt 11 is moved in a state of being temporarily pushed outward of the driven roll 13, the belt 11 is moved in a state of being temporarily depressed inward of the driven roll 14 due to the presence of the greatest insufficient eccentricity section (−E2) at the central position Rc2 of the driven roll 14. Thus, the belt 11 is moved in substantially opposite directions at the central position Rc1 in the driven roll 13 and the central position Rc2 in the driven roll 14, and the variations due to both moves are cancelled.

As a result, in the belt 11 then, a temporary speed variation of a belt portion downstream of the driven roll 14 in the rotational direction J due to the presence of the greatest exceeding eccentricity section (+E1) is reduced.

As in Exemplary Embodiment 1, the variation reduction effect is more likely to be obtained, for example, when each of the angles α1, α2 of the contact portions 11m1, 11m2 of the belt 11 in the driven roll 13 and the driven roll 14 is smaller.

In the belt driving device 1B, when a configuration is adopted in which the greatest insufficient eccentricity section (−E1) in the driven roll 13 and the greatest exceeding eccentricity section (+E2) in the driven roll 14 are in phase, once the belt driving device 1B is operated, the driven roll 13 and the driven roll 14 are moved as follows.

Specifically, in the driven roll 13 and the driven roll 14 in this situation, as selectively shown in parenthesis of FIG. 5, when the greatest insufficient eccentricity section (−E1) in the driven roll 13 reaches the central position Rc1 of the contact portion 11m1 of the belt 11, the greatest exceeding eccentricity section (+E2) in the driven roll 14 reaches the central position Rc2 of the contact portion 11m2 of the belt 11.

The belt 11 then passes through a surface portion depressed inward of the roll body 13b due to the greatest insufficient eccentricity section (−E1) at the central position Rc1 of the contact portion 11m1 of the belt 11 in the driven roll 13, thus the belt 11 is moved in a state of being temporarily depressed inward of the driven roll 13.

On the other hand, the belt 11 then passes through a surface portion bulging outward of the roll body 14b due to the greatest exceeding eccentricity section (+E2) at the central position Rc2 of the contact portion 11m2 of the belt 11 in the driven roll 14, thus the belt 11 is moved in a state of being temporarily pushed outward of the driven roll 14.

Consequently, even when the greatest insufficient eccentricity section (−E1) in the driven roll 13 reaches the central position Rc1 and the belt 11 is moved in a state of being temporarily depressed inward of the driven roll 13, the belt 11 is moved in a state of being temporarily pushed outward of the driven roll 14 due to the presence of the greatest exceeding eccentricity section (+E2) at the central position Rc2 of the driven roll 14. Thus, the belt 11 is moved in substantially opposite directions at the central position Rc1 in the driven roll 13 and the central position Rc2 in the driven roll 14, and the variations due to both moves are cancelled.

As a result, in the belt 11 then, a temporary speed variation of a belt portion downstream of the driven roll 14 in the rotational direction J due to the presence of the greatest insufficient eccentricity section (−E1) is reduced.

As in the case where the above-described configuration is adopted, the variation reduction effect is more likely to be obtained, for example, when each of the angles α1, α2 of the contact portions 11m1, 11m2 of the belt 11 in the driven roll 13 and the driven roll 14 is smaller.

As described above, in the belt driving device 1B, a speed variation of the belt 11 which occurs due to eccentricity of a driven roll, in a portion downstream of the driven roll in the rotational direction J is reduced, as compared to when one driven roll 130 is disposed as illustrated in FIG. 10B as well as to the belt driving device 1X in the comparative example illustrated in FIG. 10A.

In addition, the variation reduction effect by the belt driving device 1B is more effectively obtained than by the belt driving device 1A according to Exemplary Embodiment 1.

### Exemplary Embodiment 3

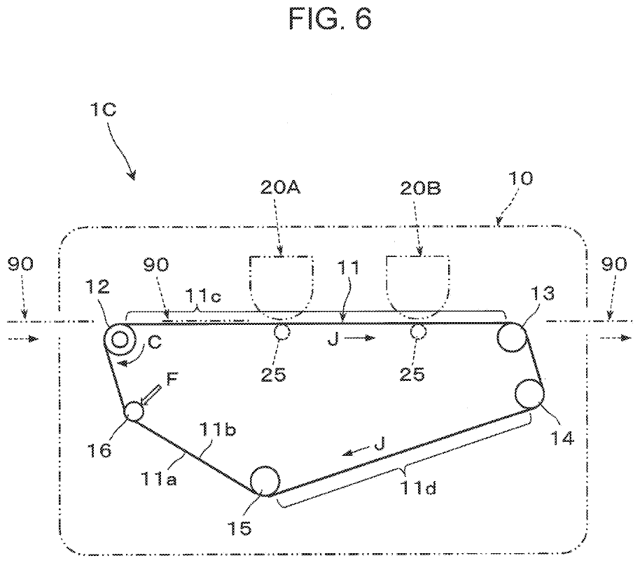

FIG. 6 conceptually illustrates a belt driving device 1C in its entirety according to Exemplary Embodiment 3. The belt driving device 1C has the same configuration as that of the belt driving device 1A according to Exemplary Embodiment 1 in that the two upstream processing units 20A, 20B are disposed on the first belt surface 11c except for the change that the downstream processing units 20C, 20D are not disposed on the second belt surface 11d.

When the belt 11 is an intermediate transfer belt or a photoreceptor belt, the two upstream processing units 20A, 20B has the same configuration as that of the two upstream processing units 20A, 20B in Exemplary Embodiment 1.

In addition, the upstream processing units 20A, 20B are configured so that the processes to be performed successively for the belt 11 are performed after mutual position alignment.

Furthermore, the driven roll 13 and the driven roll 14 use the same configuration (see FIG. 2, FIG. 3) as that of the driven roll 13 and the driven roll 14 in Exemplary Embodiment 1, or the same configuration (see FIG. 5) as that of the driven roll 13 and the driven roll 14 in Exemplary Embodiment 2.

In the belt driving device 1C in which the two upstream processing units 20A, 20B are disposed, as compared to when the driven roll 13 and the driven roll 14 are not disposed as part of driven rolls, in substantially the same manner as the operational effect described as part of the operation in Exemplary Embodiment 1, a temporary speed variation which occurs in a portion of the belt 11 upstream or downstream of the driven roll 14 in the rotational direction J is reduced.

As a result, in the belt driving device 1C, displacement of positions on the belt 11 processed by the two upstream processing units 20A, 20B is reduced, the displacement being due to the effect of the temporary speed variation which occurs in the belt 11.

Modification of Exemplary Embodiment 3

In the belt driving device 1C, as illustrated by a chain double-dashed line in FIG. 6, the belt 11 can be configured as a transport belt to transport a to-be-processed member 90 on which processing is directly performed by the two upstream processing units 20A, 20B.

In this situation, in addition to the imaging transfer unit illustrated in Exemplary Embodiment 1, the following may be applied to the upstream processing units 20A, 20B. As other examples, applicable devices include, for example, a printing device that forms an image by ejecting ink as an example of a material to the to-be-processed member 90, and a coating device that forms a coated surface, a powder adhesion surface by discharging or applying a coating material or powder as an example of a material to the to-be-processed member 90.

When the printing device is applied to the upstream processing units 20A, 20B, the belt driving device 1C constitutes part of the printing device. In addition, when the coating device is applied to the upstream processing units 20A, 20B, the belt driving device 1C constitutes part of the coating device.

In addition, as the to-be-processed member 90, for example, a sheet-like member capable of holding and transporting the belt 11 is applied. Also, the to-be-processed member 90 is fed at a required timing by a feeding unit which is not illustrated so as to be held and transported by an action such as an electrostatic action on the outer peripheral surface 11a of the belt 11 that moves in a circular manner in the rotational direction J.

In the belt driving device 1C in thus configured modification, as compared to when the driven roll 13 and the driven roll 14 are not disposed as part of the driven rolls, in substantially the same manner as the operational effect described as part of the operation in Exemplary Embodiment 1, a temporary speed variation which occurs in a portion of the belt 11 upstream or downstream of the driven roll 14 in the rotational direction J of the belt 11 is reduced.

As a result, in the belt driving device 1C in the modification, the posture of the to-be-processed member 90 maintained relative to the belt 11 is not slightly changed due to an occurrence of a temporary speed variation of the belt 11, and the to-be-processed member 90 is transported stably. Thus, displacement of positions on the to-be-processed member 90 transported by the belt 11, and processed by the two upstream processing units 20A, 20B is reduced, the displacement being due to the effect of the temporary speed variation which occurs in the belt 11.

### Exemplary Embodiment 4

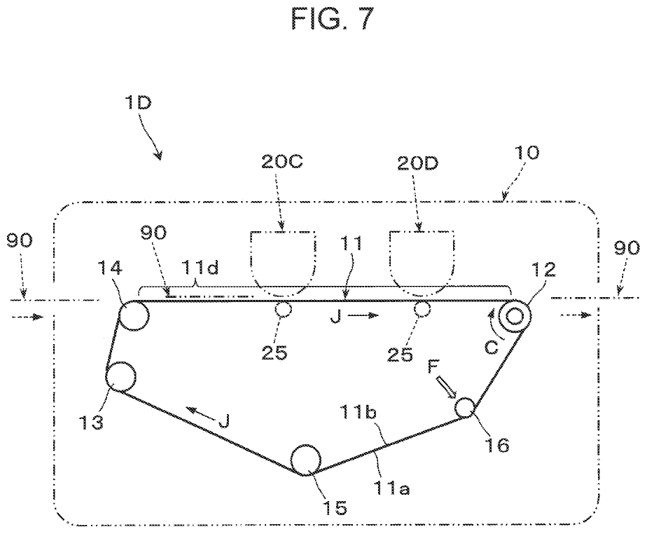

FIG. 7 conceptually illustrates a belt driving device 1D in its entirety according to Exemplary Embodiment 4. The belt driving device 1D has the same configuration as that of the belt driving device 1A according to Exemplary Embodiment 1 except that the positions where the driven rolls 13, 14 are disposed are changed, and two downstream processing units 20C, 20D are disposed on the second belt surface 11d.

In the driven roll 13 and the driven roll 14, the driven roll 13 is disposed below the driven roll 14, and their vertical arrangement relationship is opposite to the vertical arrangement relationship between the driven roll 13 and the driven roll 14 in Exemplary Embodiment 1. However, also in this situation, the driven roll 14 is disposed downstream of the driven roll 13 in the rotational direction J of the belt 11.

In addition, in Exemplary Embodiment 4, the drive roll 12 is disposed at a position with a required interval from the driven roll 14 in substantially the horizontal direction. The driven roll 15 is disposed as the lowermost driven roll at the lowest position diagonally downward from the driven roll 13 with a required interval therefrom. The driven roll 16 is disposed as a tensile force applying roll at a position between the drive roll 12 and the driven roll 15.

Furthermore, the driven roll 13 and the driven roll 14 use the same configuration (see FIG. 2, FIG. 3) as that of the driven roll 13 and the driven roll 14 in Exemplary Embodiment 1, or the same configuration (see FIG. 5) as that of the driven roll 13 and the driven roll 14 in Exemplary Embodiment 2 except that the vertical arrangement relationships are totally opposite.

The two downstream processing units 20C, 20D are configured in the same manner as the two upstream processing units 20A, 20B in Exemplary Embodiment 2. As with the second belt surface 11d in Exemplary Embodiment 1, the second belt surface 11d is a belt surface for processing work, which is first formed downstream of the driven roll 14 as the second driven roll in the rotational direction J of the belt 11.

In addition, the downstream processing units 20C, 20D are configured so that the processes to be performed successively for the belt 11 are performed after mutual position alignment.

In the belt driving device 1D in which the two downstream processing units 20C, 20D are disposed, as compared to when the driven roll 13 and the driven roll 14 are not disposed as part of driven rolls, in substantially the same manner as the operational effect described as part of the operation in Exemplary Embodiment 1, a speed variation which occurs in a portion of the belt 11 downstream of the driven roll 14 in the rotational direction J is reduced.

As a result, in the belt driving device 1D, displacement of positions on the belt 11 processed by the two downstream processing units 20C, 20D is reduced, the displacement being due to the effect of the temporary speed variation which occurs in the belt 11.

Modification of Exemplary Embodiment 4

In the belt driving device 1D, as with the belt driving device 1C in the modification of Exemplary Embodiment 3, as illustrated by a chain double-dashed line in FIG. 7, the belt 11 can be configured as a transport belt to transport the to-be-processed member 90 on which processing is directly performed by the two downstream processing units 20C, 20D.

In this situation, as in the content described in the modification of Exemplary Embodiment 3, other devices such as the imaging transfer unit, the printing device, and the coating device may be applied to the two downstream processing units 20C, 20D.

In thus configured belt driving device 1D in the modification, the operational effect obtained by the belt driving device 1C in the modification of Exemplary Embodiment 3 is similarly obtained.

### Exemplary Embodiment 5

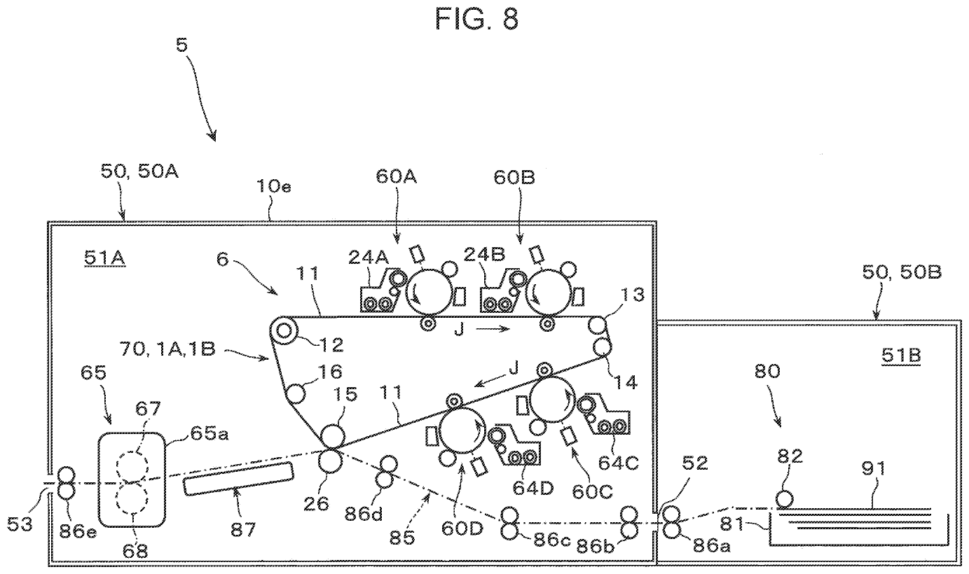

FIG. 8 conceptually illustrates an image forming apparatus 5 in its entirety according to Exemplary Embodiment 5.

As illustrated in FIG. 8, the image forming apparatus 5 has a housing 50 in a required appearance shape, and the internal space of the housing 50 includes an imaging transfer unit 6, a medium feeder 80, and a power supply, a controller which are not illustrated.

First, the housing 50 is a structure with required structure and shape by combining various support members, exterior materials. The housing 50 in Exemplary Embodiment 5 is configured to be divided into a first housing 50A that arranges and stores the imaging transfer unit 6 and others, and a second housing 50B that arranges and stores the medium feeder 80.

Next, the imaging transfer unit 6 is a unit configured to form an image composed of developer and transfer the image to a recording medium 91 which is an example of a to-be-processed member.

The imaging transfer unit 6 in Exemplary Embodiment 5 is disposed in an internal space 51A of the first housing 50A. As illustrated in FIG. 8, the imaging transfer unit 6 includes four image forming devices 60A, 60B, 60C, 60D that form a toner image composed of toner as a developer, and an intermediate transfer device 70 that delivers the toner image of each color formed and transferred by the four image forming devices 60A, 60B, 60C, 60D, and transports the toner image to a position at which the toner image is transferred to the recording medium 91.

The image forming devices 60A, 60B, 60C, 60D are devices that form a toner image composed of four toners (A, B, C, D) with different colors or types individually and exclusively. As the toner image composed of toners with different colors or types, for example, a normal toner image composed of toner of a chromatic color or an achromatic color such as yellow (Y), magenta (M), cyan (C), black (K) may be mentioned; however, the toner image is not limited to this.

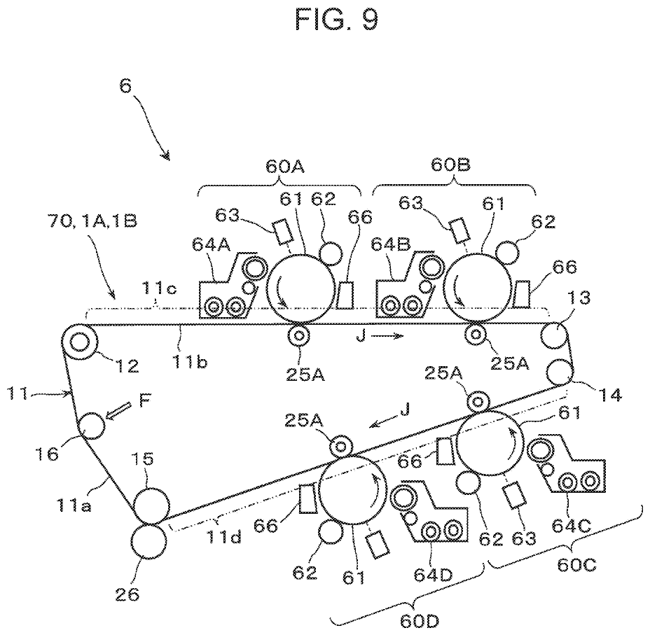

As illustrated in FIG. 9, the image forming devices 60A, 60B, 60C, 60D each have a photoreceptor drum 61 that is rotationally driven in the direction indicated by an arrow, and around the photoreceptor drum 61, devices such as a charging device 62, a latent image forming device 63, a developing device 64A, 64B, 64C, or 64D, and a drum cleaning device 66 are disposed.

Among these, the latent image forming device 63 forms an electrostatic latent image on the photoreceptor drum 61 by performing exposure on the photoreceptor drum 61 charged, based on information on an image input from a connected device, such as an information terminal device, a document reading device, to which the image forming apparatus 5 is connected. The developing devices 64A, 64B, 64C, 64D are four developing devices that each store one of four toners (A, B, C, D) to perform developing.

As illustrated in FIG. 8 and FIG. 9, the intermediate transfer device 70 is configured by disposing the belt 11 as an intermediate transfer belt; the drive roll 12 and the driven rolls 13 to 16 that rotate the belt 11 wound around the rolls; a transfer-roll first transfer device; a transfer-roll second transfer device; and a belt cleaning device which is not illustrated.

The intermediate transfer device 70 uses a belt driving device that has the belt 11 as an intermediate transfer belt, and the drive roll 12 and the driven rolls 13 to 16 that rotate the belt 11 wound around the rolls.

Also, the belt driving device of the intermediate transfer device 70 is configured as the belt driving device 1A (see FIG. 1 to FIG. 3) according to Exemplary Embodiment 1 or the belt driving device 1B (see FIG. 5) according to Exemplary Embodiment 2.

Thus, the driven roll 13 is configured as the first driven roll, and the driven roll 14 is configured as the second driven roll. Also, the driven roll 15 is the lowest driven roll, and in addition, configured as a back-up roll in the second transfer device. The driven roll 16 is configured as a tensile force applying roll.

Also, the first transfer device uses first transfer rolls 25A at the positions opposed to respective photoreceptor drums 61 across the belt 11 in the image forming devices 60A, 60B, 60C, 60D, the first transfer rolls 25A each being an example of the holding member 25 that comes into contact with the inner peripheral surface 11b of the belt 11 and presses the belt 11 against a corresponding photoreceptor drum 61 to be driven to rotate. A first transfer voltage is supplied to each first transfer roll 25A from a power supply which is not illustrated.

Furthermore, the second transfer device uses a second transfer roll 26 at the position opposed to the driven roll 15 as a back-up roll across the belt 11, the second transfer roll 26 being configured to come into contact with the outer peripheral surface 11a of the belt 11 to press the belt 11 against the driven roll 15 to be driven to rotate. A second transfer voltage is supplied to the second transfer roll 26 from a power supply which is not illustrated.

Next, the medium feeder 80 is a component that stores and feeds the recording medium 91 to be fed to the position at which second transfer is made in the intermediate transfer device 70 of the imaging transfer unit 6.

The position at which second transfer is made is the second transfer position, and in Exemplary Embodiment 5, the position is between a portion of the belt 11 supported by the driven roll 15 and the second transfer roll 26.

As illustrated in FIG. 8, the medium feeder 80 in Exemplary Embodiment 5 is disposed in an internal space 51B of the second housing 50B. Also, the medium feeder 80 includes a container 81 that stores a plurality of recording media 91 by stacking them in a required orientation; and a delivery device 82 that delivers the recording medium 91 stored in the container 81 one by one.

For example, a sheet-like medium such as recording paper is used as the recording medium 91.

Also, there is provided a medium transport path 85 to transport the recording medium 91 from the second housing 50B to the first housing 50A.

The medium transport path 85 is configured by disposing a plurality of transport rolls 86a to 86e that sandwich and transport the recording medium 91; a plurality of guide members (not illustrated) that ensure the transport space for the recording medium 91 and transport the recording medium 91; and components and devices such as a belt transport device 87.

A passage port 52 is provided between the first housing 50A and the second housing 50B to allow the recording medium 91 during transport to pass through. Also, the first housing 50A is provided with a discharge port 53 to discharge the recording medium 91 with an image formed to the outside.

Also, the imaging transfer unit 6 is provided with a fixing unit 65 that fixes, onto the recording medium 91, a toner image second transferred to the recording medium 91.

As illustrated in FIG. 8, the fixing unit 65 in Exemplary Embodiment 5 is comprised of a fixing device formed by disposing devices such as a rotating body for heating 67, a rotating body for pressurization 68 in the internal space of a housing 65a provided with an inlet port and a discharge port for the recording medium 91.

The fixing unit 65 is a fixing processor (nip part) in which a contact portion between the rotating body for heating 67 and the rotating body for pressurization 68 allows the recording medium 91 with a transferred unfixed toner image sandwiched therebetween to pass through, and the fixing processor performs processing such as heating, pressurization to fix the toner image to the recording medium 91 at the time of passing.

In the image forming apparatus 5, as illustrated in FIG. 8, the image forming devices 60A, 60B, which are part of the four image forming devices 60A, 60B, 60C, 60D, are disposed to form a toner image, and successively transfer the toner image on the first belt surface 11c which is formed as a substantially horizontal plane between the drive roll 12 and the driven roll 13. The image forming devices 60A, 60B are two upstream image forming devices, and provide a specific example of the two upstream processing units 20A, 20B (see FIG. 1) illustrated in Exemplary Embodiment 1.

In addition, the remaining image forming devices 60C, 60D of the image forming devices 60A, 60B, 60C, 60D are disposed to form a toner image, and successively transfer the toner image on the second belt surface 11d which is formed as an inclined surface between the driven roll 14 and the driven roll 15. The image forming devices 60C, 60D are two downstream image forming devices, and provide a specific example of the two downstream processing units 20C, 20D (see FIG. 1) illustrated in Exemplary Embodiment 1.

Furthermore, the four image forming devices 60A, 60B, 60C, 60D are configured so that the process of first transfer of a toner image by the image forming devices 60C, 60D corresponding to the downstream processing units is performed after alignment with the position at which the process of first transfer of a toner image is performed for the belt 11 by the image forming devices 60A, 60B corresponding to the upstream processing units.

Also, the image forming devices 60A, 60B, 60C, 60D are configured so that the processes of first transfer of a toner image are performed after mutual position alignment.

Operation of Image Forming Apparatus

Upon receiving a command to form an image by operating the four image forming devices 60A, 60B, 60C, 60D, the image forming apparatus 5 operates in the following manner.

First, each photoreceptor drum 61 in the four image forming devices 60A, 60B, 60C, 60D of the imaging transfer unit 6 starts to rotate in the direction as indicated by an arrow, and a charging operation, an exposure operation, a developing operation and a drum cleaning operation are performed. Concurrently with this, in the intermediate transfer device 70 of the imaging transfer unit 6, the belt 11 as an intermediate transfer belt starts to rotate in the rotational direction J, and a first transfer operation, a second transfer operation and a belt cleaning operation are performed.

Meanwhile, in the medium feeder 80, the recording medium 91 necessary for image formation is delivered, and the recording medium 91 is transported to the second transfer position in the intermediate transfer device 70 through the medium transport path 85.

Thus, the respective toner images formed by the image forming devices 60A, 60B, 60C, 60D are first transferred so as to be successively aligned with and superimposed on the belt 11 in the intermediate transfer device 70, then are transported to the second transfer position by the belt 11. In addition, multiple toner images first transferred to the belt 11 are second transferred to the recording medium 91 at the second transfer position.

Subsequently, the recording medium 91 with second transferred toner images is transported to the fixing unit 65 through the medium transport path 85, and a fixing operation is performed in the fixing unit 65. The recording medium 91 after fixing is discharged to the outside (a discharge container and a post-processing unit) of the first housing 50A through the medium transport path 85.

In this manner, in the image forming apparatus 5, a multiple image or a multicolor image can be formed on the recording medium 91, the image being created by positionally aligning and superimposing the toner images formed by all of the image forming devices 60A, 60B, 60C, 60D.

Note that the image forming apparatus 5 can form a multiple image or a multicolor image, or a single-color image comprised of a single toner image on the recording medium 91 by operating part (a single or multiple image forming devices) of the image forming devices 60A, 60B, 60C, 60D, the multiple or multicolor image being created by positionally aligning and superimposing multiple toner images formed by the operated image forming devices.

In the image forming apparatus 5, the belt driving device of the intermediate transfer device 70 in the imaging transfer unit 6 is comprised of the belt driving device 1A or the belt driving device 1B.

Thus, in the image forming apparatus 5, a speed variation which occurs in the belt 11 can be reduced, as compared to when one driven roll 130 is disposed as illustrated in FIG. 10B as well as when the belt driving device 1X in the comparative example illustrated in FIG. 10A is used as the belt driving device for the intermediate transfer device 70.

Therefore, in the image forming apparatus 5, displacement of the first transfer positions on the belt 11 of multiple toner images due to the speed variation occurred in the belt 11 is reduced, the multiple toner images being formed by the four image forming devices 60A, 60B, 60C, 60D.

### Modifications

Although the exemplary embodiments of the present disclosure have been described above, the present disclosure is not limited to the configurations illustrated in Exemplary Embodiments 1 to 5, and various modifications and modified implementations can be made within a range not departing from the gist of the present disclosure. Therefore, the present disclosure also includes the modification illustrated below, for example.

In the belt driving devices 1A to 1D (including the belt driving devices 1C, 1D in the modifications) according to Exemplary Embodiments 1 to 4, and the image forming apparatus 5 according to Exemplary Embodiment 5, the driven rolls other than the driven rolls 13, 14 around which the belt 11 is wound are not limited to the driven rolls 15,16, and still other driven rolls may be additionally disposed.

According to this modification, the entire form when the belt 11 is wound may be changed as needed.

Among the driven rolls, the position at which the driven roll 16 as a tensile force applying roll is disposed may be selected as appropriate.

In the belt driving device in which a tensile force applying roll is disposed, when the driven roll 130 as illustrated in FIG. 10B is disposed, the tensile force applying roll absorbs a speed variation occurred in the belt 11 to some extent due to the presence of the eccentricity sections (+E, −E) possessed by the driven roll 130. In this regard, in the belt driving device in which the driven roll 13 and the driven roll 14 illustrated in Exemplary Embodiments 1, 2 are disposed instead of the one driven roll 130, it is made possible that a speed variation of the belt 11 due to the eccentricity sections (+E, −E) present in the driven roll 13 and the driven roll 14 is unlikely to occur.

Also, depending on the conditions for application of the belt driving devices 1A to 1D, the driven roll 16 as a tensile force applying roll may be configured to be disposed to come into contact with the outer peripheral surface 11a of the belt 11 to apply a tensile force to the belt 11.

In Exemplary Embodiments 1, 2, a case has been illustrated in which the driven roll 14 is disposed downstream of the driven roll 13 in the rotational direction J of the belt 11; however, the driven roll 13 may be disposed downstream of the driven roll 14 in the rotational direction J of the belt 11.

Also, in Exemplary Embodiments 1, 2, a configuration example has been illustrated in which two upstream processing units 20A, 20B are disposed as the upstream processing units; however, the upstream processing units may be single or three or more in number.

Furthermore, in Exemplary Embodiments 1, 2, a configuration example has been illustrated in which two downstream processing units 20C, 20D are disposed as the downstream processing units; however, the downstream processing units may also be single or three or more in number.

In Exemplary Embodiment 3, a configuration example has been illustrated in which two upstream processing units 20A, 20B are disposed as the upstream processing units; however, the upstream processing units may be three or more in number.

In Exemplary Embodiment 4, a configuration example has been illustrated in which two downstream processing units 20C, 20D are disposed as the downstream processing units; however, the downstream processing units may be three or more in number.

In Exemplary Embodiment 5, the image forming apparatus 5 has been illustrated, which includes the intermediate transfer device 70 in a form in which the belt driving devices 1A, 1B are applied; however, as long as an image forming apparatus includes the intermediate transfer device 70 in such a form, necessary modifications or additions may be made. For example, the number of the image forming devices 60 in the imaging transfer unit 6 may be other than four provided that the number is multiple.

The image forming apparatus of the present disclosure may be an image forming apparatus that uses the belt driving device 1C illustrated in Exemplary Embodiment 3 or its modification as a belt driving device.

Thus configured image forming apparatus may be, for example, the image forming apparatus according to the tenth aspect of the present disclosure or the eleventh aspect of the present disclosure, in which the plurality of imaging transfer units are disposed on the second belt surface of the belt formed downstream of the second driven roll in the rotational direction.

The image forming apparatus in the present disclosure may be an image forming apparatus that uses the belt driving device 1D illustrated in Exemplary Embodiment 4 or its modification as a belt driving device.

Thus configured image forming apparatus may be, for example, the image forming apparatus according to the tenth aspect of the present disclosure or the eleventh aspect of the present disclosure, in which the plurality of imaging transfer units are disposed on the first belt surface of the belt formed downstream of the first driven roll in the rotational direction.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A belt driving device comprising:
a belt; and
a drive roll and driven rolls that rotate the belt wound around the rolls,
wherein as part of the driven rolls, a first driven roll and a second driven roll with a same roll diameter, each having a greatest exceeding eccentricity section or insufficient eccentricity section in a mutual common area are disposed in a non-displaced state in that order at positions with an interval in a rotational direction of the belt, and are driven to rotate so that greatest exceeding eccentricity sections or insufficient eccentricity sections each being the greatest exceeding eccentricity section or insufficient eccentricity section are in opposite phase at central positions in the rotational direction of contact portions of the belt with the first driven roll and the second driven roll.
   (((2)))

A belt driving device comprising:
a belt; and
a drive roll and driven rolls that rotate the belt wound around the rolls,
wherein as part of the driven rolls, a first driven roll having a greatest exceeding eccentricity section, and a second driven roll having a same roll diameter as the first driven roll and a greatest insufficient eccentricity section are disposed in a non-displaced state at positions with an interval in a rotational direction of the belt, and are driven to rotate so that the greatest exceeding eccentricity section and the greatest insufficient eccentricity section are in phase at central positions in the rotational direction of contact portions of the belt with the first driven roll and the second driven roll.
   (((3)))

The belt driving device according to (((1))) or (((2))),
wherein the first driven roll and the second driven roll are synchronized and driven to rotate.
   (((4)))

The belt driving device according to (((3))),
wherein the first driven roll and the second driven roll are coupled by a timing belt.
   (((5)))

The belt driving device according to (((1))) or (((2))),
wherein a difference between a length of a contact portion of the belt with the first driven roll and a length of a contact portion of the belt with the second driven roll is less than or equal to 20%.
   (((6)))

The belt driving device according to (((5))),
wherein the length of the contact portion of the belt with the first driven roll is equal to the length of the contact portion of the belt with the second driven roll.
   (((7)))

The belt driving device according to (((1))) or (((2))), further comprising:
a single or a plurality of upstream processing units that perform a process of transferring a material to a first belt surface of the belt formed upstream of the first driven roll in the rotational direction; and
a single or a plurality of downstream processing units that perform a process of transferring a material to a second belt surface of the belt formed downstream of the second driven roll in the rotational direction,
wherein the process of the downstream processing units is performed after alignment with a position on the belt, for which a process is performed by the upstream processing units.
   (((8)))

The belt driving device according to (((1))) or (((2))), further comprising
a plurality of upstream processing units that perform processes of transferring a material to a first belt surface of the belt formed upstream of the first driven roll in the rotational direction,
wherein the processes of the plurality of upstream processing units are performed after mutual positional alignment on the belt.
   (((9)))

The belt driving device according to (((1))) or (((2))), further comprising
a plurality of downstream processing units that perform processes of transferring a material to a second belt surface of the belt formed downstream of the second driven roll in the rotational direction,
wherein the processes of the plurality of downstream processing units are performed after mutual positional alignment on the belt.
   (((10)))

An image forming apparatus comprising:
a belt driving device having a belt, and a drive roll and driven rolls that rotate the belt wound around the rolls; and
a plurality of imaging transfer units that form image and successively transfer the images to a belt surface of the belt, formed between the drive roll and the driven rolls or between the driven rolls,
wherein the belt driving device is comprised of the belt driving device according to any one of (((1))) to (((9))).
   (((11)))

The image forming apparatus according to (((10))),
wherein part of the plurality of imaging transfer units is disposed on a first belt surface of the belt, formed upstream of the first driven roll in the rotational direction, and
a remaining part of the plurality of imaging transfer units is disposed on a second belt surface of the belt, formed downstream of the second driven roll in the rotational direction.

What is claimed is:

1. A belt driving device comprising:
a belt; and
a drive roll and driven rolls that rotate the belt wound around the rolls,
wherein as part of the driven rolls, a first driven roll and a second driven roll with a same roll diameter, each having a greatest exceeding eccentricity section or insufficient eccentricity section in a mutual common area are disposed in a non-displaced state in that order at positions with an interval in a rotational direction of the belt, and are driven to rotate so that greatest exceeding eccentricity sections or insufficient eccentricity sections each being the greatest exceeding eccentricity section or insufficient eccentricity section are in opposite phase at central positions in the rotational direction of contact portions of the belt with the first driven roll and the second driven roll.

2. A belt driving device comprising:
a belt; and
a drive roll and driven rolls that rotate the belt wound around the rolls,
wherein as part of the driven rolls, a first driven roll having a greatest exceeding eccentricity section, and a second driven roll having a same roll diameter as the first driven roll and a greatest insufficient eccentricity section are disposed in a non-displaced state at positions with an interval in a rotational direction of the belt, and are driven to rotate so that the greatest exceeding eccentricity section and the greatest insufficient eccentricity section are in phase at central positions in the rotational direction of contact portions of the belt with the first driven roll and the second driven roll.

3. The belt driving device according to claim 1,
wherein the first driven roll and the second driven roll are synchronized and driven to rotate.

4. The belt driving device according to claim 2,
wherein the first driven roll and the second driven roll are synchronized and driven to rotate.

5. The belt driving device according to claim 3,
wherein the first driven roll and the second driven roll are coupled by a timing belt.

6. The belt driving device according to claim 4,
wherein the first driven roll and the second driven roll are coupled by a timing belt.

7. The belt driving device according to claim 1,
wherein a difference between a length of a contact portion of the belt with the first driven roll and a length of a contact portion of the belt with the second driven roll is less than or equal to 20%.

8. The belt driving device according to claim 2,
wherein a difference between a length of a contact portion of the belt with the first driven roll and a length of a contact portion of the belt with the second driven roll is less than or equal to 20%.

9. The belt driving device according to claim 7,
wherein the length of the contact portion of the belt with the first driven roll is equal to the length of the contact portion of the belt with the second driven roll.

10. The belt driving device according to claim 8,
wherein the length of the contact portion of the belt with the first driven roll is equal to the length of the contact portion of the belt with the second driven roll.

11. The belt driving device according to claim 1, further comprising:
a single or a plurality of upstream processing units that perform a process of transferring a material to a first belt surface of the belt formed upstream of the first driven roll in the rotational direction; and
a single or a plurality of downstream processing units that perform a process of transferring a material to a second belt surface of the belt formed downstream of the second driven roll in the rotational direction,
wherein the process of the downstream processing units is performed after alignment with a position on the belt, for which a process is performed by the upstream processing units.

12. The belt driving device according to claim 2,
a single or a plurality of upstream processing units that perform a process of transferring a material to a first belt surface of the belt formed upstream of the first driven roll in the rotational direction; and
a single or a plurality of downstream processing units that perform a process of transferring a material to a second belt surface of the belt formed downstream of the second driven roll in the rotational direction,
wherein the process of the downstream processing units is performed after alignment with a position on the belt, for which a process is performed by the upstream processing units.

13. The belt driving device according to claim 1, further comprising
a plurality of upstream processing units that perform processes of transferring a material to a first belt surface of the belt formed upstream of the first driven roll in the rotational direction,
wherein the processes of the plurality of upstream processing units are performed after mutual positional alignment on the belt.

14. The belt driving device according to claim 2, further comprising
a plurality of upstream processing units that perform processes of transferring a material to a first belt surface of the belt formed upstream of the first driven roll in the rotational direction,
wherein the processes of the plurality of upstream processing units are performed after mutual positional alignment on the belt.

15. The belt driving device according to claim 1, further comprising
a plurality of downstream processing units that perform processes of transferring a material to a second belt surface of the belt formed downstream of the second driven roll in the rotational direction,
wherein the processes of the plurality of downstream processing units are performed after mutual positional alignment on the belt.

16. The belt driving device according to claim 2, further comprising
a plurality of downstream processing units that perform processes of transferring a material to a second belt surface of the belt formed downstream of the second driven roll in the rotational direction,
wherein the processes of the plurality of downstream processing units are performed after mutual positional alignment on the belt.

17. An image forming apparatus comprising:
a belt driving device having a belt, and a drive roll and driven rolls that rotate the belt wound around the rolls; and
a plurality of imaging transfer units that form images and successively transfer the images to a belt surface of the belt, formed between the drive roll and the driven rolls or between the driven rolls,
wherein the belt driving device is comprised of the belt driving device according to claim 1.

18. An image forming apparatus comprising:
a belt driving device having a belt, and a drive roll and driven rolls that rotate the belt wound around the rolls; and
a plurality of imaging transfer units that form image and successively transfer the images to a belt surface of the belt, formed between the drive roll and the driven rolls or between the driven rolls,
wherein the belt driving device is comprised of the belt driving device according to claim 2.

19. The image forming apparatus according to claim 17,
wherein part of the plurality of imaging transfer units is disposed on a first belt surface of the belt, formed upstream of the first driven roll in the rotational direction, and
a remaining part of the plurality of imaging transfer units is disposed on a second belt surface of the belt, formed downstream of the second driven roll in the rotational direction.

20. The image forming apparatus according to claim 18,
wherein part of the plurality of imaging transfer units is disposed on a first belt surface of the belt, formed upstream of the first driven roll in the rotational direction, and
a remaining part of the plurality of imaging transfer units is disposed on a second belt surface of the belt, formed downstream of the second driven roll in the rotational direction.
